(19) United States
(12) Patent Application Publication
(10) Pub. No.: US 2013/0084427 A1
(43) Pub. Date: Apr. 4, 2013

(54) FLOOR MAT AND METHODS

(71) Applicant: Randall Rob Ernst, Rancho Mirage, CA (US)

(72) Inventor: Randall Rob Ernst, Rancho Mirage, CA (US)

(21) Appl. No.: 13/252,164

(22) Filed: Oct. 3, 2011

(51) Int. Cl. B32B 3/00; B05D 5/02

(52) U.S. Cl. 428/141; 427/210

(57) ABSTRACT

A floor mat comprises an elastomeric foam sheet having an upper surface and a lower surface. A polymer layer covers the upper surface of the elastomeric foam sheet, and a textured layer covers the lower surface of the elastomeric foam sheet, the textured layer comprising texture features.

### BACKGROUND

Embodiments of the present invention relate to a floor mat and related methods of fabrication.

Floor mats are used for cushioning, impact protection, chemical protection, decorative purposes, and other applications. For example, anti-fatigue floor mats are used as a cushion for people who stand for extended periods of time during the day. In industrial facilities, floor mats are used as floor coverings along fabrication and assembly lines both for reducing fatigue of workers as well as protection from the impact of heavy objects. In shopping facilities, anti-fatigue floor mats are also used below cashier stands to reduce cashier fatigue. In residential and commercial kitchens, floor mats can be used to reduce fatigue of standing chefs and other kitchen workers. Gyms can also use cushioning floor mats to prevent damage to the floor from heavy weights. Floor mats can also be used to protect the underlying floor from the paint or staining in industrial or garage applications, and to protect the underlying floor from impact in gyms.

Sponge material is often used to fabricate floor mats, especially anti-fatigue floor mats, as the sponge material provides adequate cushioning and impact resistance. However, sponge materials often easily tear or rip up during normal use with applied stresses and strains. Still further, sponge material can also lose their cushioning properties with excessive periods of compression or tension. Sponge material can also accumulate moisture leading to the growth of fungus which can cause rotting of the sponge material or promote allergies in certain people. Conventional sponge mats also often slip along the floor when lateral or sheer stresses are applied to the mats.

For reasons including these and other deficiencies, and despite the development of various types of floor mats and methods of their fabrication, further improvements in the structure and fabrication of floor mats are continuously being sought.

### SUMMARY

A floor mat comprises an elastomeric foam sheet having an upper surface and a lower surface. A polymer layer covers the upper surface of the elastomeric foam sheet, and a textured layer covers the lower surface of the elastomeric foam sheet, the textured layer comprising texture features.

A method of forming a floor mat comprises providing an elastomeric foam sheet having an upper surface and a lower surface. A liquid polymer is applied over the upper surface of the elastomeric foam sheet to form a polymer layer. The polymer layer is allowed to set. A liquid polymer is applied over the lower surface of the elastomeric foam sheet to form a textured layer having texture features.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1A is a perspective partial section view of a portion of an exemplary embodiment of a floor mat covering a floor in a building structure;

FIG. 1B is a perspective view of another exemplary embodiment of a floor mat having a textured coating on its upper surface;

FIG. 1C is a perspective view of another exemplary embodiment of a floor mat having a logo;

FIG. 1D is a perspective view of another exemplary embodiment of a floor mat having a textured layer on its lower surface;

FIG. 2 is a flowchart of an exemplary embodiment of a process for forming a floor mat;

FIG. 3 is a schematic perspective, partial sectional view of a sprayer for spraying a liquid polymer on an upper surface of an elastomeric foam sheet to form a polymer layer;

FIG. 4 is a schematic perspective, partial sectional view of texture features being formed by applying a mold imprint on a conformal polymer layer on the upper surface of a sponge sheet;

FIG. 5 is a schematic perspective, partial sectional view of another embodiment of texture features formed on a polymer layer on the upper surface of a sponge sheet;

FIG. 6 is a schematic perspective, partial sectional view of a logo being applied on a liquid polymer layer sprayed onto the surface of an already set polymer layer using a mold imprint; and

FIG. 7 is a schematic perspective, partial sectional view of a sprayer spraying a textured layer comprising texture features on a lower surface of an elastomeric foam sheet.

### DESCRIPTION

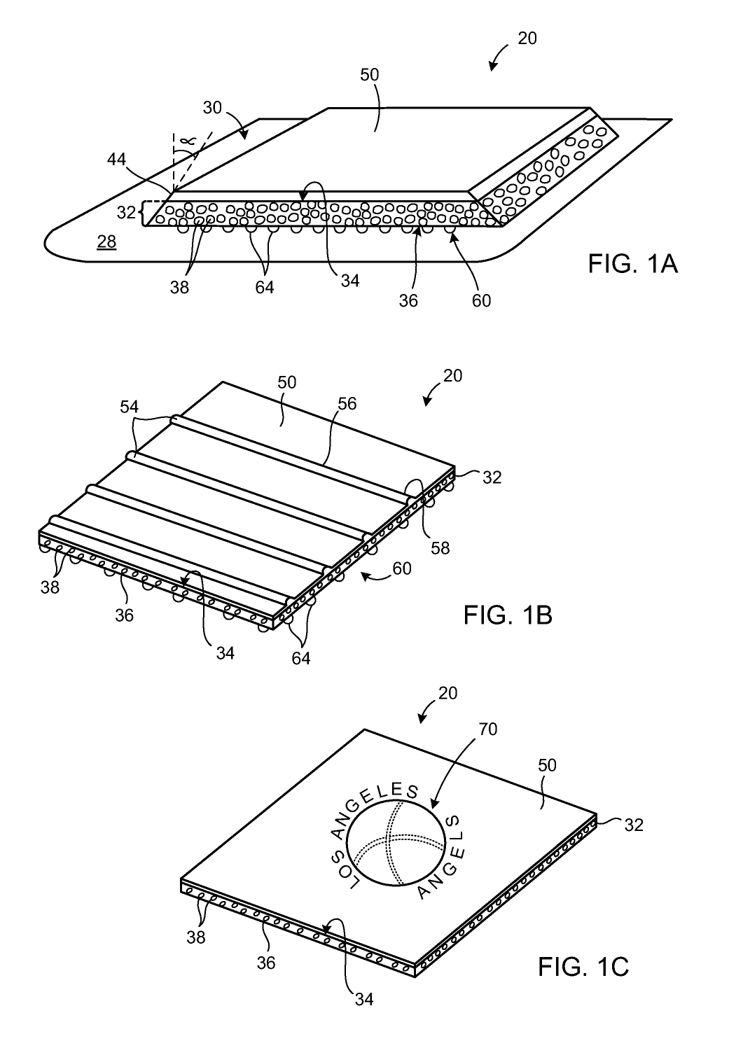

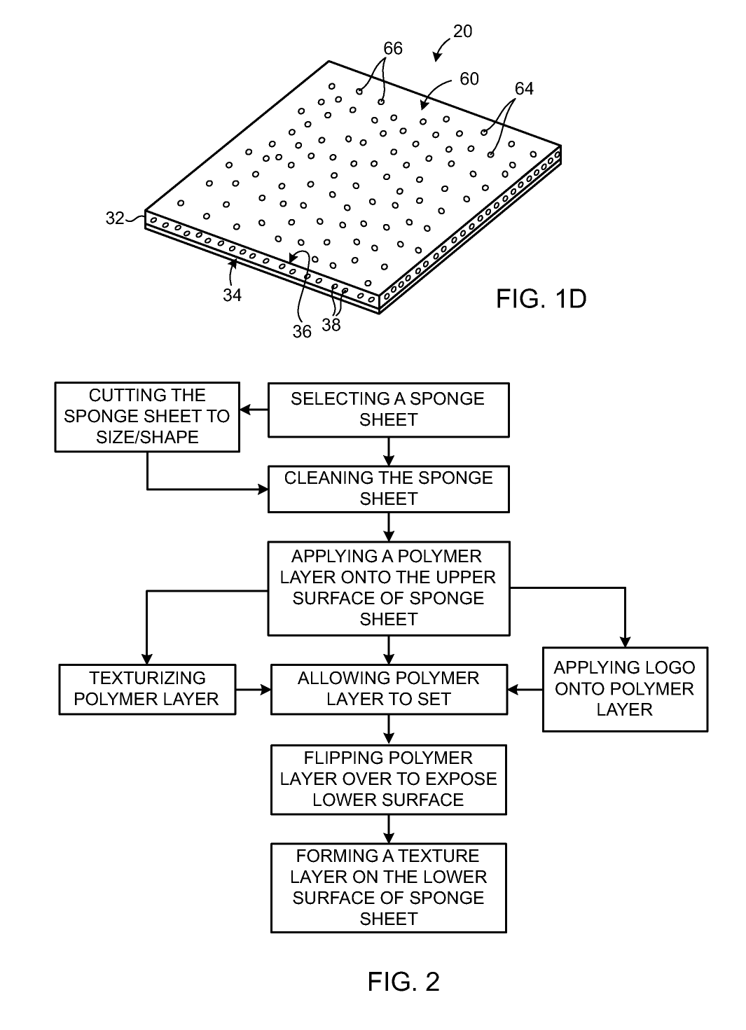

A floor mat 20 according to an embodiment of the present invention can provide a floor covering having excellent durability and a springy and resilient feel that reduces fatigue for users, protection of the underlying floor, and have other uses. The floor mat 24 that can be placed directly onto a floor 28 in a building structure 30, as for example shown in FIG. 1A, to reduce fatigue of occupants of the building structure. For example, the floor mat 20 can be used in industrial facilities, such as automotive fabrication or repair facilities, gyms, garages, shopping lines, and many other applications. The floor mat 20 provides excellent durability and resistance to abrasion, good tear and impact resistance, and cushioning suitable for anti-fatigue or impact resistance, rendering the mat suitable for handling chemicals, stresses and strains, and for many different applications and environments.

The floor mat 20 comprises an elastomeric foam sheet 32 having an upper surface 34 and a lower surface 36, as shown in FIG. 1A. The elastomeric foam sheet 32 comprises elastomeric foam composed of elastic porous mass of cells 38, which can form a cushioning, force absorbing, sheet. For example, elastomeric foam can be a mixture of open or closed cells 38, pores, or holes, which are randomly shaped and sized. The elastomeric foam sheet 32 can be a foam sheet, open cell elastomeric foam sheet or closed cell elastomeric foam sheet.

The elastomeric foam sheet 32 has to be sufficiently resilient and compressible to serve as a cushioning layer. For example, the elastomeric foam sheet 32 can be sufficiently compressible to serve as an anti-fatigue mat. In one version, the elastomeric foam sheet 32 provides a compression deflection of at least about 25% of the thickness of the elastomeric foam sheet, at an applied pressure of from about 2 psi to about 12 psi, or even at an applied pressure of from about 5 to about 9 psi. The tensile strength of the elastomeric foam sheet 32 can be from about 25 psi to about 100 psi, or even from about 50 psi to about 80 psi. The deformation of the sheet 32 can range from about 100% to about 300%, or even from about 160% to about 220% in the thickness or linear direction. In one version, the density of a suitable elastomeric foam sheet 32 is from about 150 to about 600 kg/cm³.

In one version, the elastomeric foam sheet 32 is a closed cell elastomeric foam sheet having spaced apart closed cells 38 (as shown), which are hollow three-dimensional structures that serve to cushion and absorb applied stresses. The hollow three-dimensional structures can be shaped as spheres, half spheroids, polygons, hexagonal or rectangular forms, cylinders, or have other complex shapes. The closed cells 38 can also have a cross-sectional shape that varies from the upper surface 34 of the mat to the lower surface 36 of the mat, for example a conical shape, such as a cone.

In one version, the elastomeric foam sheet 32 comprises a polymer, such as polyvinyl chloride, nitrile rubber, or mixtures thereof. Suitable elastomeric foam sheets 32 comprising closed cell PVC/NBR blend elastomeric foam sheets include Armafoam IE2™ from Armacell of Mebane, N.C., and XUNL™ from Fostek of Bedford, Va.. Polyvinyl chloride (PVC) is a thermoplastic polymer comprising a vinyl polymer constructed of repeating vinyl groups (ethenyls) having one hydrogen replaced by chloride. Nitrile rubber also known as Buna-N, Perbunan or NBR, is synthetic rubber formed by the polymerization of acrylonitrile with butadiene. Suitable commercially available nitrile rubbers include Nipol, Krynac and Europrene. Nitrile butadiene rubber (NBR) is a family of unsaturated copolymers of 2-propenenitrile and various butadiene monomers (1,2-butadiene and 1,3-butadiene).

In one version, the elastomeric foam sheet 32 is cut to a particular shape or size and beveled, as shown in FIG. 1A. The elastomeric foam sheet 32 can be cut from a roll or from precut sheets. The beveled edge 44 of the elastomeric foam sheet 32 is beveled to a predefined angle (alpha) α, such as an angle of at least about 30 degrees, or even from about 45 to about 85 degrees. Advantageously, the beveled edge 44 of the elastomeric foam sheet 32 reduces tearing and delamination of the polymer layer 50 from the underlying elastomeric foam sheet 32 at the edge of the elastomeric foam sheet.

A polymer layer 50 covers the upper surface 34 of the elastomeric foam sheet 32. In one embodiment, the polymer layer 50 has a substantially uniform thickness which varies by less than 25% across the length of the mat, or even by less than 10% across the length of the mat. The polymer layer 50 provides a flat, resilient layer that increases the resilience of the floor mat 20 to the external environment. The polymer used to fabricate the polymer layer 50 has to be resilient to withstand impacts and bumps, and also have a sufficiently high flexibility to remain adhered to, and not delaminate from, the flexible underlying elastomeric foam sheet 32 when the elastomeric foam sheet 32 bends or flexes with an applied pressure. The polymer layer 50 is a single, continuous, monolithic layer that is sufficiently thick to protect the underlying elastomeric foam sheet 32 from abrasion or tearing by applying the overlying stresses. In one version, the polymer layer 50 comprises a thickness of at least about 0.025 inch, or even from about 0.04 to about 0.25 inch, or in one example, from about 0.05 to about 0.08 inch. When the elastomeric foam sheet 32 comprises a beveled edge 44, the polymer layer 50 covers the beveled edge 44 in the same thickness as that of the flat portion of the elastomeric foam sheet, and can be a straight edge or also beveled.

The polymer layer 50 also has to be sufficiently strong to prevent tearing or cracks in the ongoing sponge layer. In one version, the polymer layer 50 has a tensile strength of at least about 10 MPa (1450 psi), or even from about 17 MPa (2500 psi) to about 24MPa (3500 psi), for example about 22 MPa (3200 psi). The polymer layer 50 can also have a tear strength of at least about 35,000 N/m (200 pli—pounds of force per linear inch), or even from about 44,000 N/m (250 pli) to about 70,000 N/m (400 pli), or even 57,000 N/m (325 pli). The tear strength is the force required to tear a specified test specimen divided by the specimen thickness. Still further, the polymer layer 50 can have a direct impact strength of at least about 900 N/cm (500 lbs/in) or even at least about 1250 N/cm (700 lbs/in). The impact resistance of the polymer layer 50 should be sufficiently high at low temperatures, or even subzero temperatures, to prevent brittle fracture or cracking of the polymer at these low temperatures when impacted. The polymer layer 50 should also be sufficiently fire resistant to be a class 1 fire rated material as measured under the ASTM designated test E84, entitled “Standard Method of Test for Surface Burning Characteristics of Building Materials.”

In one version, the polymer layer 50 is composed at least partially, or substantially entirely, of a polymer, such as for example, polyurea, polyurethane, or mixtures thereof. For example, the polymer layer 50 can be composed partially or entirely of polyurea. Generally, urea or carbamide has the chemical formula (NH₂)₂CO in which two amine groups (—NH₂) are joined by a carbonyl functional group (C═O). Polyurea is an elastomer comprising alternating monomer units of isocyanate and amine which have reacted with each other to form urea linkages. Polyurea is derived from the reaction product of (i) an isocyanate, and (ii) a synthetic resin blend component through step-growth polymerization. The isocyanate can be aromatic or aliphatic in nature, a monomer or polymer, or any variant reaction of isocyanates, quasi-prepolymer or a prepolymer. The prepolymer or quasi-prepolymer can be made of an amine-terminated polymer resin, or a hydroxyl-terminated polymer resin. The resin blend may be made up of amine-terminated polymer resins, and/or amine-terminated chain extenders. The resin blend may also contain additives such as hydroxyls, for example, pre-dispersed pigments in a polyol carrier. Urea can also be formed from the reaction of isocyanates and water to form a carbamic acid intermediate which decomposes releasing carbon dioxide and leaving behind an amine, which then reacts with another isocyanate group to form the polyurea linkage.

The polymer layer 50 can also be composed partially or entirely of polyurethane, which is a polymer composed of organic units joined by urethane or carbamate groups. Polyurethane can be formed through step-growth polymerization, by reacting an isocyanate monomer with another monomer having at least two hydroxyl or alcohol groups (—OH), in the presence of a catalyst. In one example, the polymer layer 50 is made from a polyisocyanate which is a molecule with two or more isocyanate functional groups, R—(N═C═O)_{n≧2}, for example, a diisocyanate polymer having two isocynate groups. Diisocyanate polymers are manufactured for reactions with polyols in the production of polyurethanes. The isocyanate group reacts with the hydroxyl functional group to form a urethane linkage. If a diisocyanate is reacted with a compound containing two or more hydroxyl groups (polyol) or alcohol groups, the resultant long chain polymer is polyurethane. A suitable polyurethane polymer can be made from liquid diisocyanates and liquid polyether or polyester diols. For example, a polyisocyanate having the formula R—(N═C═O)_{n≧2} is reacted with a polyol having the formula R′—(OH)_{n≧2} to produce a polyurethane reaction product that is a polymer containing the urethane linkage, —RNHCOOR′—. In one example, the polyurethane comprises DiphenylmethaneDiisocyanate (MDI).

In one example, the polyurethane comprises an isocyanate polymer having the formula R—(N═C═O), where R is a carbon-hydrogen molecule, and the isocyanate group is —N═C═O. Molecules that contain two isocyanate groups are called diisocyanates. These molecules are also referred to as monomers or monomer units, since they themselves are used to produce polymeric isocyanates that contain three or more isocyanate functional groups. Isocyanates can be classed as aromatic, such as diphenylmethane diisocyanate (MDI) or toluene diisocyanate (TDI); or aliphatic, such as hexamethylene diisocyanate (HDI) or isophorone diisocyanate (IPDI). An example of a polymeric isocyanate is polymeric diphenylmethane diisocyanate, which is a blend of molecules with two-, three-, and four- or more isocyanate groups, with an average functionality of 2.7. Isocyanates can be further modified by partially reacting them with a polyol to form a prepolymer. A quasi-prepolymer is formed when the stoichiometric ratio of isocyanate to hydroxyl groups is greater than 2:1. A true prepolymer is formed when the stoichiometric ratio is equal to 2:1.

The polyurethane also includes a polyol (—OH) _{n≧2}. Molecules that contain two hydroxyl groups are called diols, those with three hydroxyl groups are called triols, etc. In practice, polyols are distinguished from short chain or low-molecular weight glycol chain extenders and cross linkers such as ethylene glycol (EG), 1,4-butanediol (BDO), diethylene glycol (DEG), glycerine, and trimethylolpropane (TMP). Polyols are polymers in their own right. They are formed by base-catalyzed addition of propylene oxide (PO), ethylene oxide (EO) onto a hydroxyl or amine containing initiator, or by polyesterification of a di-acid, such as adipic acid, with glycols, such as ethylene glycol, polyethylene glycol, or dipropylene glycol (DPG). Polyols extended with PO or EO are polyether polyols. Polyols formed by polyesterification are polyester polyols. The choice of initiator, extender, and molecular weight of the polyol greatly affect its physical state, and the physical properties of the polyurethane polymer. Important characteristics of polyols are their molecular backbone, initiator, molecular weight, % primary hydroxyl groups, functionality, and viscosity

The polyurethane also includes a catalyst such as a tertiary amine, such as for example, dimethylcyclohexylamine, and organometallic compounds, for example dibutyltin dilaurate or bismuth octanoate. Suitable catalysts can also be chosen based on whether they favor the urethane (gel) reaction, such as 1,4-diazabicyclo[2.2.2]octane (also called DABCO or TEDA), or the urea (blow) reaction, such as bis-(2-dimethylaminoethyl)ether, or specifically drive the isocyanate trimerization reaction, such as potassium octoate.

The polymer layer 50 can be flat and smooth as shown in FIG. 1A, or have gripping features 54 to enhance gripping off the surface of the polymer layer 50 by people standing or walking on the floor 20, as shown in FIG. 1B. In the example shown the gripping features 54 comprise spaced apart, longitudinal ridges 56 having curved apexes 58. For example, the gripping features 54 can be longitudinal ridges 56 that extend along a length of the floor mat 20, and have a height of from about 0.03 to about 0.1 inch, and even a width of from about 0.01 to about 0.04 inch. The gripping features 54 can also be spiral ridges, circular or arcuate ridges, instead of longitudinal ridges. Still further, the gripping features 54 can also comprise grooves instead of ridges, or a combination of grooves and ridges. In yet other embodiments, the gripping features can comprise diamond-shaped polyhedra 59, as for example, shown in FIG. 5.

Still further, the floor mat 20 can also have a logo 70 stamped, pressed or inked, onto the polymer layer 50, as shown in FIG. 1C. For example, the logo 70 can be embossed lettering (as shown) of the name of the company or facility using the floor mat 20. In this version, the logo 70 comprises raised lettering that is fabricated directly in the polymer form 40. The logo 70 can also be a transfer, inked, stenciled, or painted design corresponding to a similar trademark of the company using the floor mat 20. Conventional transfers, stencils and other such methods can be used to form the logo 70.

In the version shown in FIGS. 1A and 1D, the floor mat 20 further comprises a textured layer 60 covering the lower surface 36. The textured layer 60 comprises texture features 64 that provide a better grip of the floor 28 of the building structure 30.

The textured layer 60 can also be provided to enhance drainage from underneath the floor mat 20. In one example, the texture features 64 comprise a plurality of bumps 66 that are spaced apart from one another, as shown in FIG. 1C. In one version, the bumps 66 comprise a rounded protrusion having a height of from about 0.03 to about 0.1 inch, or even a width or diameter of from about 0.01 to about 0.04 inch. The bumps 66 can have a semi-spherical shape with a flattened top. Instead of bumps 66, the texture features 64 can also comprise other shapes, such as diamond-shaped polyhedra, cubes, cylinders or mesas, polygons, or still other shapes as would be apparent to those of ordinary skill in the art. The texture features 64 can be spaced apart from one another by an average distance of at least about 0.05 inch.

An exemplary embodiment of a process for forming a floor mat 24 will be illustrated with reference to the flowchart of FIG. 2. Initially, a roll or single layer of a elastomeric foam sheet 32, such as an open or closed cell elastomeric foam sheet, is selected. The elastomeric foam sheet 32 should be resilient and cushioning and closed off on its upper and lower surfaces, 34, 36. By closed off it is meant that the closed cells 38 do not extend through the entire thickness of the elastomeric foam sheet 32. The selected elastomeric foam sheet 32 is checked so that it does not have any burrs or tears on the edges. Thereafter, both the upper and lower surfaces 34, 36, respectively, of the elastomeric foam sheet 32 are cleaned using a wipe dipped in a solvent such as alcohol.

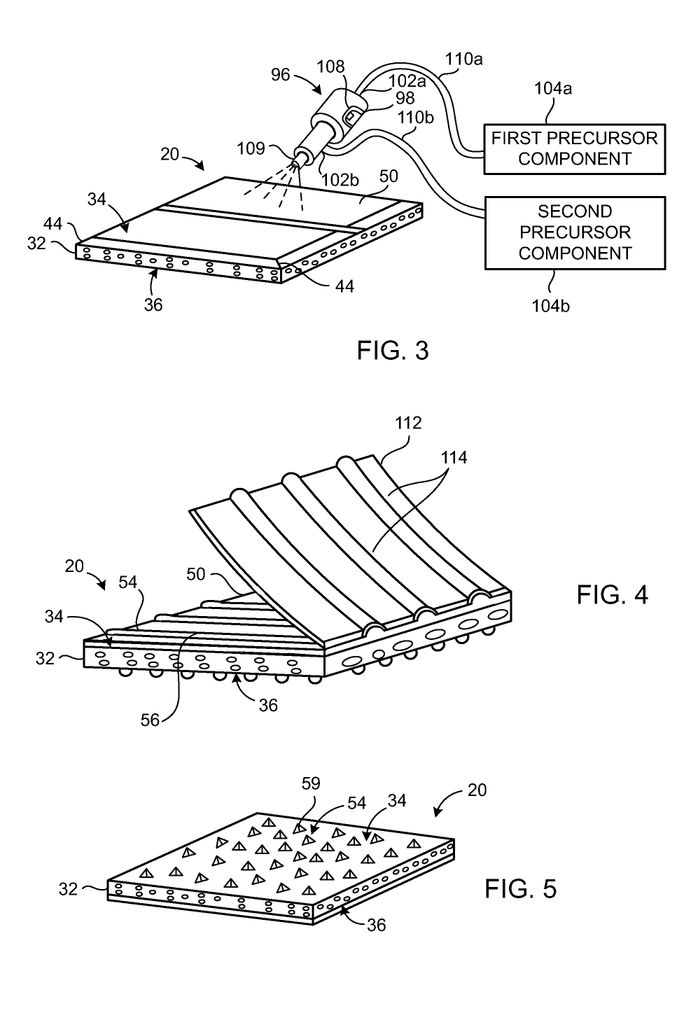

The elastomeric foam sheet 32 can be coated with the polymer layer 50 on its upper surface 34 as it is being pulled out from a roll (not shown), or after the elastomeric foam sheet 32 has been cut to a desired size and shape, as shown in FIG. 3. For example, the elastomeric foam sheet 32 can be cut to be rectangular in shape having a length of from about 1 foot to about 20 feet, and a width of from about 1 foot to about 8 feet. The elastomeric foam sheet 32 can also be cut to form arcuate or circular shapes, or even square shapes. Typically, the elastomeric foam sheet 32 is cut using a die cutting apparatus, table saw, or band saw. Thereafter, the edges of the elastomeric foam sheet 32 can beveled to the desired angle with a suitable cutting tool or machine.

The polymer layer 50 is then formed over the upper surface 34 of the elastomeric foam sheet 32 by applying a liquid polymer, which after it sets and cures, forms a resilient and durable polymer layer 50. In one version, the polymer layer 50 is formed as a flat layer covering the entire upper surface 34 of the elastomeric foam sheet 32. In one version, the flat polymer layer 50 is fabricated to have a substantially uniform thickness, by which it is meant that the thickness varies by less than 25% across the length of the resultant mat, or even varies by less than 10%. While a substantially flat polymer layer provides a smooth surface to walk on, the polymer layer 50 can also have gripping features 54 to provide a better gripping surface for walking upon.

The precut elastomeric foam sheet 32 coated with a polymer layer 50 which can be coated onto the elastomeric foam sheet by spraying, painting, or dipping. The polymer layer 50 can be formed, for example, from a polymer comprising a polyurethane, polyurea, or mixtures thereof. In one example, the polymer layer 50 is made from a liquid polymer which is sprayed onto the elastomeric foam sheet 32 with a sprayer 96 to form the polymer layer 50, as shown in FIG. 3. In one example, the liquid polymer is capable of setting in less than 5 minutes. The ambient application temperature of the room should be from about 40 to about 110° F. The sprayer 96 can be used in a spray booth (not shown) if the liquid polymer or its vapor should not be inhaled. In one version, the sprayer 96 comprises a spray gun 98 having multiple inlets, such as for example first and second inlets 102a,b, respectively, to separately receive the first precursor component 104a and the second precursor component 104b, respectively. Additional or fewer precursor components can be used depending on the composition of the polymer used in the mold layer 92.

The spray gun 98 is capable of pressurizing, heating and premixing the first and second precursor components 104a,b to a desired temperature. For example, the spray gun 98 can comprise a heater 108 capable of heating the precursor components 104a,b to a temperature of, for example, from about 140 to about 200° F., or even from about 150 to about 170° F., before spraying. The sprayer 96 pressurizes the precursor components 104a,b using hydraulic pressure from a pump (not shown), and pumps the pressurized components through a sprayer nozzle 109 to atomize the same. The sprayer nozzle 109 can be cleared or cleaned by passing compressed air therethrough from an air compressor (not shown) which is turned on prior to spraying from the spray gun 98. The pressurized components are mixed in a mixing chamber 99 in the spray gun 98, and then sprayed at a pressure of at least about 1500 psi, or even from about 2000 to about 3000 psi, or even from about 2000 to about 2500 psi. A suitable sprayer 96 is a two component, high-pressure sprayer, such as a GRACO H-XP2 reaction coating sprayer, and a suitable heated, dual inlet, spray gun 98 is a GRACO FUSION AIR purge spray gun with a sprayer nozzle such as a model 2222 nozzle, all of which are available from Graco Inc., Minneapolis, Minn..

In one version, the polymer layer 50 is composed of polyurea, polyurethane, or mixtures thereof, and formed by spraying a mixture of first and second precursor components 104a,b through a heated spray gun 98 to heat and mix the components together as they are sprayed onto the surface of the elastomeric foam sheet 32. The first and second precursor components 104a,b are separately introduced into the sprayer gun 98 of the sprayer 96 through separate first and second tubes 110a,b. Each tube 110a,b is fed from a tank comprising the first precursor component 104a or second precursor component 104b. The first and second precursor components 104a,b and the tubes 110a,b are maintained at temperatures of from about 150 to about 190° F. The two precursor components 104a,b are mixed together in the heated spray gun 98 prior to being ejected onto the surface of the elastomeric foam sheet 32 as shown in FIG. 3.

A color can also be premixed with a component of the polymer so that the cured polymer has a predefined color. For example, commonly used colors can include white, gray, tan, red or black. The premixed polymer is sprayed uniformly onto the elastomeric foam sheet 32 while the sprayer 96 is moved across the upper surface 34 of the elastomeric foam sheet 32, to achieve a polymer layer 50 comprising a polyurethane polymer having a thickness of at least about 0.05 in, or even from about 0.1 to about 0.5 in.

In one exemplary embodiment, the polymer used for the mold layer 92 comprises polyurea. The polyurea is made by mixing a first precursor component 104a with a second precursor component 104b. The first precursor component 104a is a blend comprising polymethylene polyphenyl isocyanate (from about 10 to about 40 weight %), 4, 4′ diphenylmethane diisocyanates (MDI) (from about 10 to about 40 weight %), MDI prepolymer (CAS No. 39420-98-90) comprising partially reacted isocyanate polymer which has been reacted with a polyol to form a prepolymer (from about 20 to about 60 weight %), and tris(B-chloropropyle) phosphate (from about 1 to about 20 weight %). For example, the MDI pre-polymer can be formed, for example, from polyols such as polyethylene adipate (a polyester) and poly(tetramethylene ether) glycol (a polyether). A suitable first precursor component comprises Chemthane 7061A FR, from Chemline Inc, St. Louis, Mo.. In the same embodiment, the second precursor component 104b comprises a mixture of amines and other reaction catalyzing additives. For example, the second precursor component can comprise polyoxypropylenediamine (from about 20 to about 60 weight %), polyoxyalkyleneamine (from about 10 to about 30 weight %), aromatic amines (from about 1 to about 30 weight %), decabromodiphenyl oxide (from about 1 to about 10 weight %) and antimony trioxide (from about 0 to about 5 weight %). The premixed polymer is sprayed uniformly onto the elastomeric foam sheet 32 to achieve a polymer layer 50 composed of polyurea.

In another exemplary embodiment, the polymer used for the polymer layer 50 comprises a mixture of polyurethane and polyurea. In this version, the first precursor component 104a is a diphenylmethane diisocyanate (MDI) pre-polymer blend. For example, the first precursor component 104a can comprise diphenylmethane diisocyanates (from about 20 about 50 weight%) which contain 4, 4′ diphenylmethane diisocyanates (MDI) (approximately 27 weight %) and MDI isomers. The first precursor component 104a is commercially available under the tradename GatorHyde CG-75, Component A, from aforementioned Chemline. In the same embodiment, the second precursor component 104b comprises a polyether polyol system containing aromatic diamines. For example, the second precursor component 104b can comprise polypropylene glycol in a concentration of from about 60 to about 90 weight %, and an aromatic diamine such as diethyltoluenediamine (DETDA) in a concentration of less than 20 weight %. The second precursor component 104b is commercially available under the tradename GatorHyde CG-75, Component B, from aforementioned Chemline.

In yet another exemplary embodiment, the polymer used for the polymer layer 50 also comprises a mixture of polyurethane and polyurea. In this version, the first precursor component 104a is also a diphenylmethane diisocyanate (MDI) pre-polymer blend. In this version, the first precursor component 104a comprises polyurethane prepolymer in a concentration of about 60 weight %, diphenylmethane diisocyanate with mixed isomers in a concentration of about 20 to weight %, and 4, 4′ diphenylmethane diisocyanates (MDI) in a concentration of from about 18 weight %. The first precursor component 104a is commercially available under the tradename GatorHyde CG, Component A, from aforementioned Chemline, Inc. In the same embodiment, the second precursor component 104b comprises a polyether polyol system containing aromatic diamines. For example, the second precursor component 104b can comprise polypropylene glycol in a concentration of from about 60 to about 90 weight %, and an aromatic diamine such as diethyltoluenediamine (DETDA) in a concentration of less than 20 weight %. The second precursor component 104b is commercially available under the tradename GatorHyde CG, Component B, from aforementioned Chemline, Inc.

After the polymer layer 50 is formed to the desired thickness by spraying polyurethane polymer onto the elastomeric foam sheet 32, the coated polymer layer 50 is allowed to set by allowing the layer to cool in the atmosphere for at least about 20 seconds, or even for at least about 30 seconds. The setting process causes condensation and polymerization of the polymer of the polymer layer 50 to form a flexible and coherent layer. The resultant floor mat 20 comprises a polymer layer 50 having an external surface 56 that is a smooth surface.

Instead of a smooth surface, gripping features 54 can also be formed on the polymer layer 50, as shown in FIGS. 4 and 5. Referring to FIG. 4, gripping features 54 comprising longitudinal ridges 56 having apexes 58 can be formed on the polymer layer 50. In one fabrication method, a thin polymer layer is sprayed over an already set polymer layer 50, and before the thin polymer layer becomes set or cured, a mold imprint 112 having longitudinal recesses 114 corresponding in shape to the longitudinal ridges 56 is pressed onto the fluid and polymer layer and allowed to set to create the gripping features 54 on the surface of the polymer layer 50.

During fabrication, commonly used debonding agent can be sprayed onto the surface of the mold imprint 112 to facilitate release of the mold imprint 112 from the polymer layer 50 after it has set. Suitable debonding agents can be, for example, a mixture of light hydrocarbons, organic solvent or oil, which are insoluble in water. In one example, the debonding agent comprises light aliphatic naphtha which comprises a complex mixture of hydrocarbon molecules generally having between 5 and 12 carbon atoms. Light aliphatic naphtha is the distillate of crude oil comprising the fraction boiling between 30° C. and 90° C. Light aliphatic naphtha comprises hydrocarbon molecules with from about 5 to about 6 carbon atoms. In one version, the debonding agent comprises MR-515-H™, a light aliphatic naphtha fabricated by Chem-Trend Limited Partnership, Howell, Mich.. The debonding agent can be applied onto the surface of the preform 86 by spraying, painting or even dipping, to form thin debonding layer 90 having, for example, a thickness of less than about 1 mm, or even less than 0.5 mm.

In another example, as shown in FIG. 5, the gripping features 54 comprises a Levant pattern, spaced apart diamond-like polyhedra 59, or other shapes of spaced apart bumps or recesses, tetrahedrons, polyhedrons, or other shapes. For example, the gripping features can have a height of from about 0.02 inch to about 0.4 inch. Advantageously, the gripping features 54 can also increase the strength of the polymer layer 50 to impacts, tensile stresses, and other strains, and also provide better gripping for people standing or walking on the floor mat 20. The gripping features 54 can be formed using a mold imprint 112 having the desired recess shape imprinted therein (not shown), as described above.

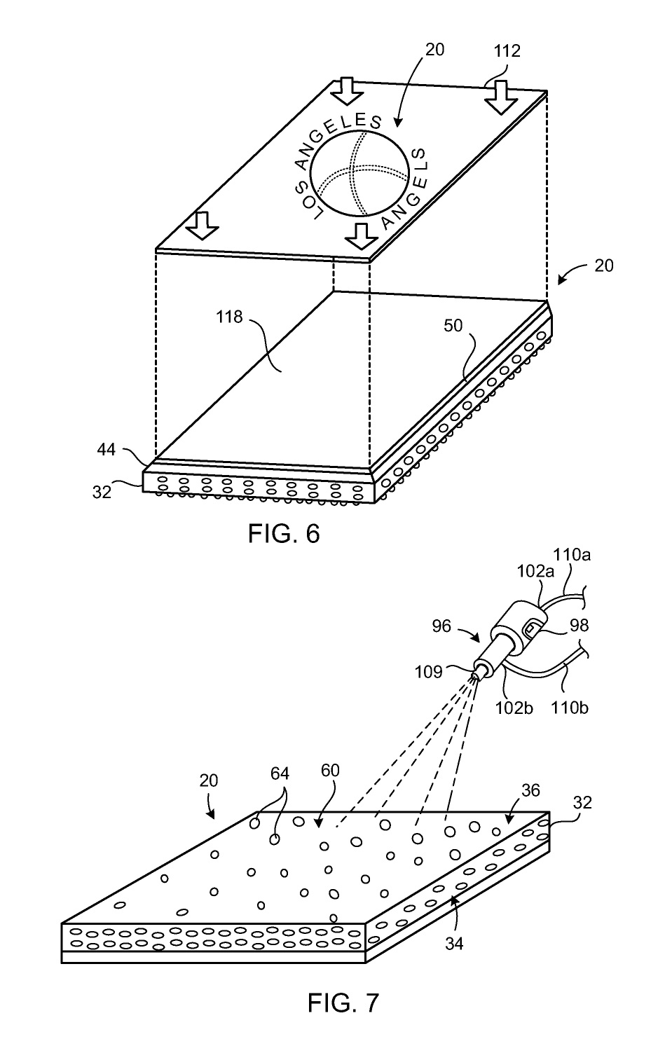

In still another version, as shown in FIG. 6, a logo 70 comprising embossed lettering of the name of the company or facility which will use the floor mat 20 is imprinted on the polymer layer 50 of the floor mat 20. The imprinted logo 70 can be formed by pressing a mold imprint 112 having a negative or recessed imprint of the logo thereon, onto a thin fluid polymer layer 118 sprayed over surface of an already set polymer layer 50, as shown. The indented pattern of text or design that is a reverse image of the logo 70 is transferred directly into the thin polymer layer 118 which bonds to the underlying set polymer layer 50 to form a single layer of polymer. As before, a debonding agent can be applied to the surface of the mold imprint 112 to facilitate release of the mold imprint 112 from the set polymer pattern formed in the thin uncured polymer layer 118. Instead, of an embossed are imprinted logo, the logo 70 formed on the polymer layer 50 can also be a stenciled, transfer, inked, or painted design that is applied to a finished floor mat 20 using conventional methods.

After completing fabrication of the polymer layer 50 on the upper surface 34 of the elastomeric foam sheet 32, optionally, the lower surface 36 of the elastomeric foam sheet 32 can be treated. In one version, the elastomeric foam sheet 32 is flipped over to expose the lower surface 36, which is then cleaned with a wipe dipped in a solvent, such as alcohol. Thereafter, the settings of the sprayer 96, spray gun 98 and sprayer nozzle 109, are adjusted to obtain a discontinuous or “splotchy” spray from the spray gun that generates texture features 64 on the lower surface 36 of the elastomeric foam sheet 32, as shown in FIG. 7. In this method, the sprayer 96 sprays a thin discontinuous layer of polymer onto the lower surface to form a textured layer 60 having texture features 64. For example, the sprayer 96 can be held at a distance of from about 1 to about 2 feet from the lower surface 36 of the elastomeric foam sheet 32 and the sprayer nozzle 109 adjusted to obtain a spray mist that generates spaced apart nodules separated by empty spaces or a thin polymer layer. The distance creates In one version, a sprayer nozzle 19 adjusted by pulsing the trigger of the sprayer nozzle 109 on and off at a rate of from about 1 pulse per second to 10 pulses per second, manually or automatically. The polymer used to form the textured layer 60 can be the same polymer as that previously described to form the polymer layer 50, or a different polymer. Suitable polymers include polyurea, polyurethane, or mixtures thereof. After spraying the textured layer 60 under lower surface 36 of the elastomeric foam sheet 32, the textured layer is allowed to set for sufficient time to allow condensation or curing of the polymer, as described above for the polymer layer 50.

In yet another version, the lower surface 36 of the elastomeric foam sheet 32 is treated to form a textured layer 60 having texture features 64 using a mold imprint 112. In this version, the mold imprint 112 has a mold surface with a negative three-dimensional image of the spaced apart texture features 64 to be formed. As before, a thin uncured polymer layer 118 is sprayed onto the lower surface 36 of an elastomeric foam sheet 32 (not shown) and while the thin surface polymer layer is still fluid, the mold imprint is pressed into the thin uncured polymer layer 118 to form the texture features 64, such as the Levant pattern, diamond-polyhedra features, or other features. A debonding agent can also be applied to the surface of the mold imprint to facilitate separation. After pressing and removing the mold imprint 112 from the thin uncured polymer layer 118, protrusions or recesses 76 corresponding to the shape of the texture features 64 are imprinted onto the lower surface 34 of the elastomeric foam sheet 32, as shown in FIGS. 1A and 1D.

The floor mat 20 described herein provides a resilient and durable surface that can withstand abrasion and tearing in harsh environments. Still further, the floor mat 20 provides a sponge interior that has good cushioning capabilities and is useful as an anti-fatigue mat for industrial and other applications. Still further, the sealing both the upper and lower surfaces of the floor mat 20 increases the resistance of the floor mat 20 to the environment and prevents excessive absorption of moisture into the floor mat 20.

While particular structures and fabrication steps are used to illustrate embodiments of the floor mat 20 of the present invention, it should be understood that other structures or sequences of process steps can also be used as would be apparent to one of ordinary skill in the art. For example, the material used to fabricate the polymer layer 50 or the textured layer 60 of the floor mat 20 can be substituted with other types of materials, such as for example, composite materials or other polymers. Still further, the spraying process steps can be changed to dipping or other coating processes as would be apparent to those of ordinary skill in the art. Therefore, the spirit and scope of the appended claims should not be limited to the description of the preferred versions contained herein.

What is claimed is:

1. A floor mat comprising:
(a) an elastomeric foam sheet having an upper surface and a lower surface;
(b) a polymer layer covering the upper surface of the elastomeric foam sheet; and
(c) a textured layer covering the lower surface of the elastomeric foam sheet, the textured layer comprising texture features.

2. A floor mat according to claim 1 wherein the elastomeric foam sheet comprises a compression deflection of at least about 25% of the thickness of the elastomeric foam sheet, at an applied pressure of from about 2 psi to about 12 psi.

3. A floor mat according to claim 1 wherein the elastomeric foam sheet comprises a closed cell elastomeric foam sheet.

4. A floor mat according to claim 1 wherein the polymer layer comprises polyurea, polyurethane, or mixtures thereof.

5. A floor mat according to claim 1 wherein the polymer layer comprises a tensile strength of at least about 10 MPa.

6. A floor mat according to claim 1 wherein the polymer layer comprises a tear strength of at least about 35,000 N/m.

7. A floor mat according to claim 1 wherein the polymer layer comprises direct impact strength of at least about 900 N/cm.

8. A floor mat according to claim 1 wherein the polymer layer comprises a thickness that varies by less than 25%.

9. A floor mat according to claim 1 wherein the texture features of the textured layer comprise bumps.

10. A floor mat according to claim 9 wherein the bumps comprise a height of from about 0.03 to about 0.1 inch.

11. A method of forming a floor mat, the method comprising:
(a) providing an elastomeric foam sheet having an upper surface and a lower surface;
(b) applying a liquid polymer over the upper surface of the elastomeric foam sheet to form a polymer layer having substantially uniform thickness;
(c) allowing the polymer layer to set; and
(d) applying a liquid polymer over the lower surface of the elastomeric foam sheet to form a textured layer having texture features.

12. A method according to claim 11 comprising providing an elastomeric foam sheet comprising a closed cell elastomeric foam sheet.

13. A method according to claim 11 wherein the polymer layer comprises polyurea, polyurethane, or mixtures thereof.

14. A method according to claim 11 comprising applying a liquid polymer capable of setting in less than 5 minutes.

15. A method according to claim 11 comprising applying a liquid polymer that sets to form a polymer layer comprising at least one of the following properties:
(i) a tensile strength of at least about 10 MPa;
(ii) a tear strength of at least about 35,000 N/m; and
(iii) a direct impact strength of at least about 900 N/cm.

16. A method according to claim 11 comprising applying a liquid polymer to form a polymer layer comprises a thickness that varies by less than 25%.

17. A method according to claim 11 comprising forming texture features comprising bumps.

18. A method according to claim 17 wherein the bumps comprise a height of from about 0.03 to about 0.1 inch.

19. A floor mat comprising:
(a) a closed cell elastomeric foam sheet having an upper surface and a lower surface;
(b) a polymer layer covering the upper surface of the closed cell elastomeric foam sheet; and
(c) a textured layer covering the lower surface of the closed cell elastomeric foam sheet, the textured layer comprising texture features.

20. A floor mat according to claim 19 wherein the polymer layer comprises polyurea, polyurethane, or mixtures thereof.

21. A floor mat according to claim 19 wherein the polymer layer is composed of a polymer having at least one of the following properties:
(1) a tensile strength of at least about 10 MPa;
(2) a tear strength of at least about 35,000 N/m; and
(3) a direct impact strength of at least about 900 N/cm.
